(19) United States
(12) Patent Application Publication
(10) Pub. No.: US 2016/0379222 A1
(43) Pub. Date: Dec. 29, 2016

(54) ESCALATION OF COMMUNITY CONTENT TO ASSOCIATED CASE

(71) Applicant: salesforce.com, inc., San Francisco, CA (US)

(72) Inventors: Chetanya Chauhan, San Francisco, CA (US); Michael Quoc Luu, San Francisco, CA (US); Vinodh Rajagopal, Sunnyvale, CA (US); Peter White, San Francisco, CA (US)

(21) Appl. No.: 14/752,312

(22) Filed: Jun. 26, 2015

(51) Int. Cl. G06Q 30/00; G06Q 50/00

(52) U.S. Cl. CPC G06Q 30/016; G06Q 50/01

(57) ABSTRACT

Disclosed are methods, apparatus, systems, and computer program products for escalating community content to an associated case. Characteristics of community content can be compared with rules to generate a customer service case record based on the community content.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This patent document relates generally to escalating community content to an associated case, and more specifically, to generating a customer service case record from community content.

### BACKGROUND

“Cloud computing” services provide shared resources, software, and information to computers and other devices upon request. In cloud computing environments, software can be accessible over the Internet rather than installed locally on in-house computer systems. Cloud computing typically involves over-the-Internet provision of dynamically scalable and often virtualized resources. Technological details can be abstracted from the users, who no longer have need for expertise in, or control over, the technology infrastructure “in the cloud” that supports them.

### BRIEF DESCRIPTION OF THE DRAWINGS

The included drawings are for illustrative purposes and serve only to provide examples of possible structures and operations for the disclosed inventive systems, apparatus, methods and computer program products for escalating community content to an associated case. These drawings in no way limit any changes in form and detail that may be made by one skilled in the art without departing from the spirit and scope of the disclosed implementations.

FIG. 1 shows a system diagram of an example of architectural components 100 for escalating community content to a case according to some implementations.

FIG. 2 shows a flowchart of an example of escalating community content to a case.

FIG. 3 shows an example of community content according to some implementations.

FIG. 4 shows an example of community content data associated with customer relationship management (CRM) records according to some implementations.

FIG. 5 shows another example of community content data according to some implementations.

FIG. 6A shows a block diagram of an example of an environment 10 in which an on-demand database service can be used in accordance with some implementations.

FIG. 6B shows a block diagram of an example of some implementations of elements of FIG. 6A and various possible interconnections between these elements.

FIG. 7A shows a system diagram illustrating an example of architectural components of an on-demand database service environment 1200 according to some implementations.

FIG. 7B shows a system diagram further illustrating an example of architectural components of an on-demand database service environment according to some implementations.

### DETAILED DESCRIPTION

Examples of systems, apparatus, and methods according to the disclosed implementations are described in this section. These examples are being provided solely to add context and aid in the understanding of the disclosed implementations. It will thus be apparent to one skilled in the art that implementations may be practiced without some or all of these specific details. In other instances, certain process/method operations, also referred to herein as “blocks,” have not been described in detail in order to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the blocks of methods shown and described herein are not necessarily performed in the order indicated. It should also be understood that the methods may include more or fewer blocks than are indicated. In some implementations, blocks described herein as separate blocks may be combined. Conversely, what may be described herein as a single block may be implemented in multiple blocks.

Various implementations described or referenced herein are directed to different systems, apparatus, methods, and computer-readable storage media for escalating community content to an associated case. In some scenarios, a community website (or other type of community resource) operated by an organization may host services for users (e.g., the organization's customers, employees, partners, automated devices, etc.) to ask questions and receive answers from other users as community content. For example, a customer may ask a question regarding how to get a technical feature of a product sold by the organization to function properly by posting a thread asking about the technical feature on a message board (or forum). Other customers may respond to the thread by posting a response. Eventually, the thread or topic related to the question may include several responses from other customers.

The responses of the other customers provide a type of crowd-sourced form of technical support. However, there may be dozens of responses with many different answers. When another viewer with the same question finds the thread later, determining the best answer among the responses may be difficult.

Moreover, the organization may have customer service agents providing answers to questions, for example, based on emails, phone calls, and social media messages (e.g., posting on a social network) from customers. Generally, the customer service agents may be trained on the organization's products, and therefore, may be able to provide a better and more accurate answer than another customer. Customer service agents may be able to provide an answer to a problem by accessing a customer service case record stored in a database system. Customer service case records can include data indicating the name of the customer requesting a solution to a problem, detail on the problem, possible solutions, and other types of information useful for the customer service agent to resolve the user's problem. As a result, customer service agents may access a customer service case record, see what problem the customer is having, and then provide an answer, for example, by email, phone, or social media.

Accordingly, a customer's problem can be solved by other customers (e.g., crowd-sourced) on a community website, a customer service agent through customer service case records, or both. However, having the customer service agent to also engage with customers on the community website may be difficult. For example, the content on the community website may not be easily accessible to customer service agents. Moreover, a large number of questions posted on the community website may be difficult for customer service agents to monitor independently of their own customer service case records and systems.

In some implementations, questions posted by customers on a community website can be “elevated” into a customer service case record. That is, a customer service case record can be generated based on community content posted on the community website. The customer service agents can then provide an answer using a customer service case record, which can also be used to update the community website. As a result, both other customers and customer service agents may be able to provide the solution to the problem posed by the customer's question.

For example, a customer may post a question regarding a problem and several other users may provide different solutions. A customer service agent may be able to see the question posted by the customer and the answers posted by the other customers and then select the best answer provided among the other customers so that others with a similar question may easily determine the best answer to the problem.

Additionally, certain questions may be elevated, or escalated, into a customer service record by applying a variety of rules to escalate community content to a customer service case record. For example, community content can be escalated based on characteristics of the post (e.g., the content of the question, the customer, the time it was asked, the title of the post, etc.). Certain community content also may be elevated based on customer relationship management (CRM) records associated with the customer posting the question, or other characteristics of the customer, such as the customer's employer or status of their social networking accounts. Multiple rules can be applied to sift through the community content and escalate certain questions asked by customers to customer service case records. Accordingly, a question posted on a community content website (or other type of resource) may be escalated into a customer service record for a customer service agent to engage with the customer to resolve the problem.

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

In some but not all implementations, the disclosed methods, apparatus, systems, and computer-readable storage media may be configured or designed for use in a multi-tenant database environment.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

A “user profile” or “user's profile” is generally configured to store and maintain data about a given user of the database system. The data can include general information, such as name, title, phone number, a photo, a biographical summary, and a status, e.g., text describing what the user is currently doing. As mentioned below, the data can include messages created by other users. Where there are multiple tenants, a user is typically associated with a particular tenant. For example, a user could be a salesperson of a company, which is a tenant of the database system that provides a database service.

The term “record” generally refers to a data entity, such as an instance of a data object created by a user of the database service, for example, about a particular (actual or potential) business relationship or project. The data object can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

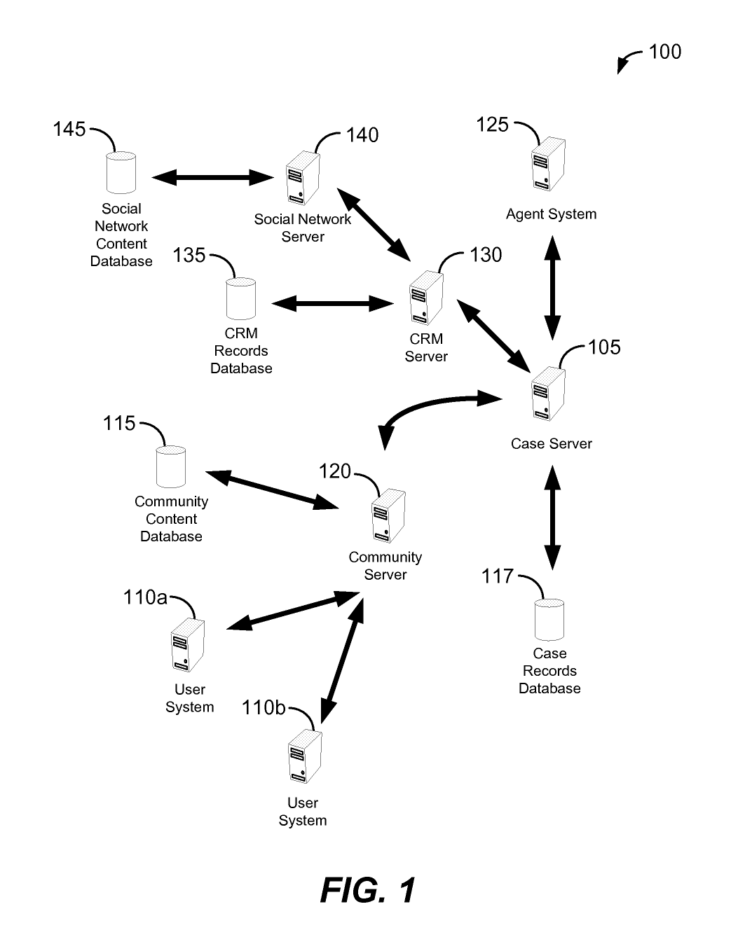

FIG. 1 shows a system diagram of an example of architectural components 100 for generating a customer service case record according to some implementations. Architectural components 100 in FIG. 1 implement a database system that may provide communications to be transmitted among a variety of different hardware and/or software components. In FIG. 1, architectural components 100 include user systems 110a and 110b, community server 120, community content database 115, case server 105, case record database 117, CRM server 130, CRM records database 135, social network server 140, social network content database 145, and agent system 125. In other implementations, the functionality in architectural components 100 may be implemented in more or less servers. For example, case server 105 and CRM server may be implemented within a single server. As another example, CRM server 130 may be implemented with multiple servers.

User systems 110a and 110b may be any type of computing device. For example, user systems 110a and 110b may be portable electronic devices such as smartphones, tablets, laptops, wearable devices (e.g., smart watches, optical head mounted displays), etc. User systems 110a and 110b may be another server or a desktop computer. Additionally, user systems 110a and 110b may be different types of computing devices. For example, user system 110a may be a desktop computer whereas user system 110b may be a smartphone.

In some implementations, community server 120 may provide functionality for customers of an organization to post questions or comments and receive answers from other customers as well as customer service agents. For example, community server 120 may be a website accessible by user systems 110a and 110b. In this example, user systems 110a and 110b may use a web browser to navigate to a URL of a website with a discussion board (or forum), register an account, post a message, post a new thread (i.e., start a new collection or organization of posts), read other threads, etc. In another example, community server 120 may provide a different type of online service or website providing a repository of questions and answers. In another example, user systems 110a and 110b may be smartphones with an app installed which allows similar functionality by accessing community server 120. In another example, user systems 110a and 110b can be automated devices (e.g., operating within the Internet of Things) that can provide content to community server 120.

Accordingly, community server 120 may provide a resource for the organization's customers to ask questions to seek a solution to a problem, provide answers to questions of other customers, and read the questions and answers. User systems 110a and 110b may provide data corresponding to a question (e.g., content indicating the particular question) or a response to a question and the data may be stored in community content database 115 as community content data or items. The data stored in community content database 115 also may be retrieved by community server 120 and provided to user systems 110a and 110b, for example, when the customers want to read previously-provided questions and answers from other customers.

The responses of the other customers provide a type of crowd-sourced form of technical support since other customers can try to help each other by posting answers to the initial question. This may create a repository of questions with corresponding answers in community content database 120. As such, other customers with similar questions may search for community content where someone else experienced the same problem and receive answers as solutions to the problem without contacting the organization directly.

However, in some scenarios, customer service agents may also provide answers to supplement the answers provided by other customers, provide better answers, or to indicate that an answer already provided by another customer is the best answer. In FIG. 1, agent system 125 may be used by a customer service agent to also provide answers to the questions posted to community server 120 and stored in community content database 115. For example, a subset of community content in community content database 115 may be elevated to a customer service case record stored in case record database 117 and accessible to agent system 125 through case server 105. That is, certain customer questions posted to the community website may generate a corresponding customer service case record for a customer service agent to quickly respond to the question on the community website.

For example, certain customers may be determined to be important or influential, and therefore, the question (as a form of community content) posted by the customer to community server 120 may be elevated to a customer service case record so that agent system 125 may be able to quickly identify and answer the question for the customer. Other factors discussed later herein also may be considered to elevate a question in community content to a customer case record.

Community server 120, case server 105, or a combination of both community server 120 and case server 105 may make the determination to generate a new customer case record from community content by applying a set of rules. Rules metadata detailing the conditions for a question to be elevated to a customer service case record may be stored in community server 120, case server 105, or a combination of both community server 120 and case server 105.

Accordingly, agent system 125 may communicate with case server 105, which may include functionality for managing customer service case records in case record database 117. Customer service case records stored in case record database 117 may include data helpful for a customer service agent to resolve a customer's problem and may be sourced from community server 120 as well as other sources (e.g., a customer service case record may be generated by agent system 125 when answering a phone call from a customer).

Case record database 117 may include data indicating the customer's name, content from community content database 115, history of problems (i.e., prior interactions with a customer service agent), and other details related to the customer. In some implementations, case server 105 may obtain community content data from community content database 115 and generate a customer service case record stored in case record database 117. Agent system 125 may then access case server 105 to view the customer service case record stored in case record database 117 and be provided with the data from community content database 115 (e.g., the post from a customer asking the question as well as the posts from other customers providing answers to the question), as well as other details related to the customer asking the question.

The customer service agent may then use agent system 125 to provide an answer to the question, which may be provided to case server 105 and stored in case record database 117 (e.g., the customer service case record may be updated with the answer), and also provided to community server 120 and stored in community content database 115 so that the customer service agent's answer is visible to user systems 110a and 110b on the community content resource provided by community server 120 (e.g., the website). As such, a customer service agent may be able to provide answers to the questions provided by user systems 110a and 110b to community server 120 without directly accessing the community website provided by community server 120. Moreover, other customers may be able to provide their own answers before or after the customer service agent provides an answer with case server 105.

Some community content (e.g., questions) in community content database 115 can also be elevated to a customer service case record in case record database 117 based on a customer relationship management (CRM) record associated with the customer asking the question, or the customer's employer. That is, the rules metadata may indicate certain characteristics of a customer's CRM records to be considered when determining whether to elevate a question to a customer service case record. For example, case server 105 may communicate with CRM server 130, which has access to CRM records database 135. CRM records database 135 may include a variety of CRM records that can be searched and analyzed to see if a customer posting a question to community server 120 has a corresponding CRM record which indicates certain characteristics of the customer that signify that the customer's questions should be quickly answered by a customer service agent.

Moreover, social network (or social media) data from social network server 140 can also be used to elevate a question in community content database 115 to a customer service case record in case record database 117. CRM server 130 may communicate with social network server 140 and receive a profile of a customer from social network content database 145. The profile can be analyzed to determine characteristics of the customer's social network profile. For example, customers with a high number of followers on a social network can have their questions provided to the community website elevated to customer service case records because they may be influential and should have customer service agents alerted to their problems. Accordingly, a variety of rules based on characteristics of customers, community content, CRM data, and social network data may be applied to determine whether community content should be escalated to a customer service case record.

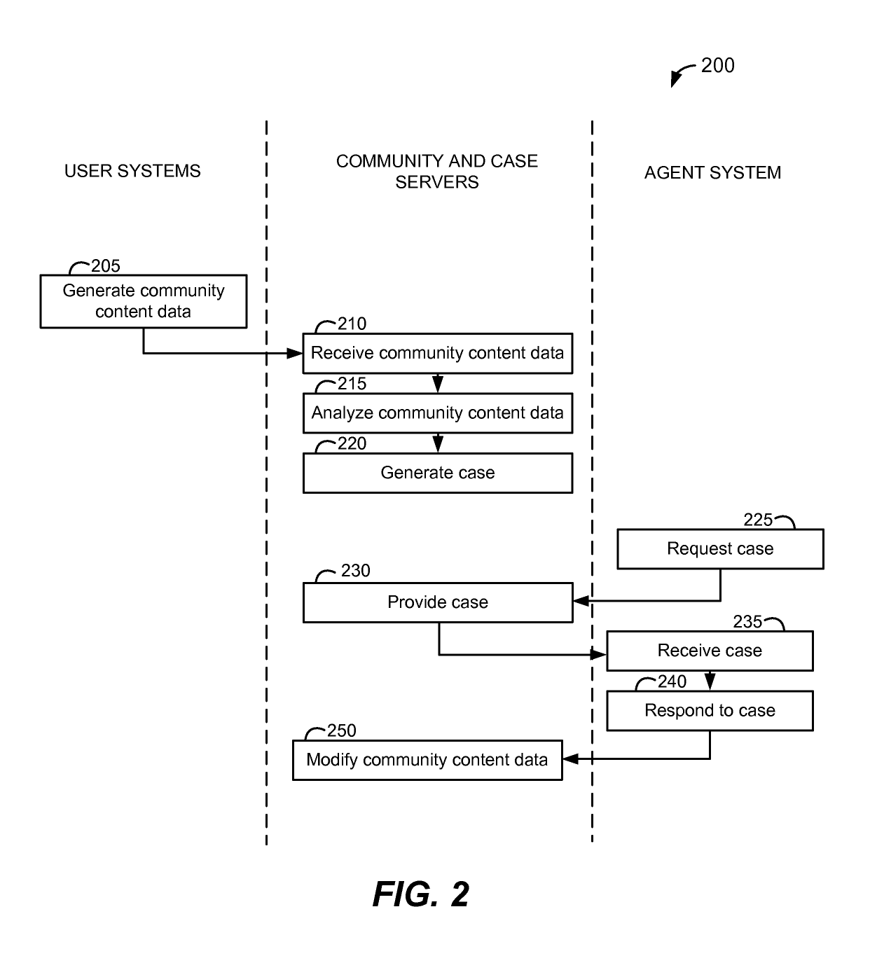

FIG. 2 shows a flowchart of an example of generating a customer service case record. Method 200 (and other methods described herein) may be implemented by the architectural components of FIG. 1. In various implementations, blocks may be reordered, omitted, combined, or split into additional blocks for method 200, as well as other methods described herein.

In method 200, at block 205, community content data may be generated. For example, the community content data may be generated by a customer filling out a form with fields on a website, desktop software program, smartphone app, or other source. When submitted, this may generate community content data indicating, for example, a username or real name of the customer asking a question, a time and date when the question was submitted, a title, content with the customer's message including the question (e.g., textual detail, images, videos, etc.), and other types of data useful for solving a customer's problem.

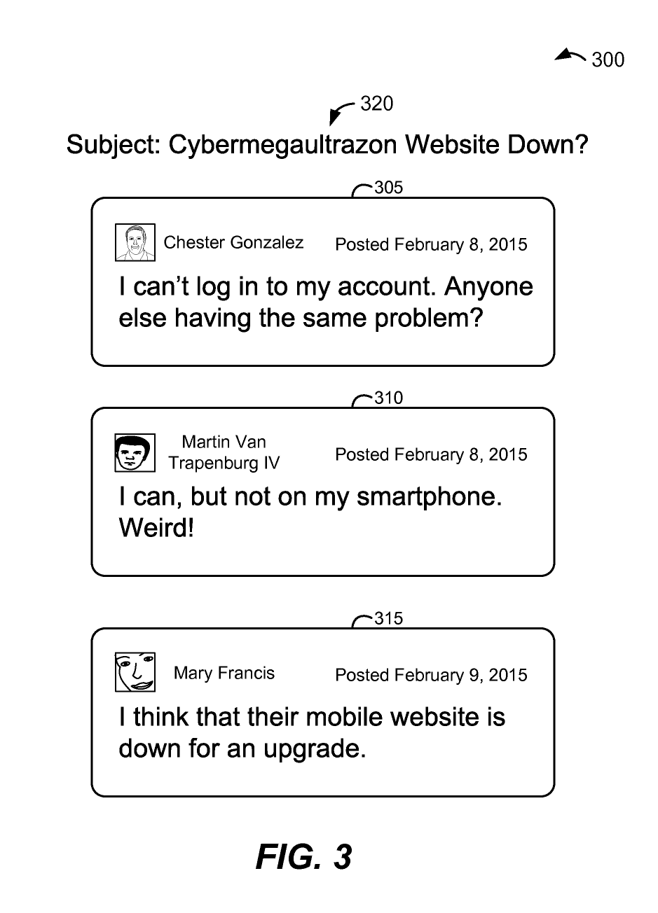

At block 210, a community server may receive the generated community content data and store the data in a database. FIG. 3 shows an example of community content data according to some implementations. In FIG. 3, a visual representation of community content 300 shows a customer asking a question in post 305. For example, the community content data in FIG. 3 may be stored in community content database 115 in FIG. 1 and shown to user systems 110a and 110b as a visual representation as in FIG. 3. In FIG. 3, a customer named Chester Gonzalez posts a thread with title 320 of “Cybermegaultrazon Website Down?” (indicating the subject matter) and a corresponding post 305 describing a problem and asking a question. Additional customers also may generate community content data by responding to post 305. For example, in FIG. 3, posts 310 and 315 represent community content data providing responses from other customers including possible answers or comments to post 305.

At block 215, the community content data may be analyzed. In some implementations characteristics of community content 300 can be analyzed and certain characteristics may be used to determine that community content 300 should be elevated to a customer service case record for a customer service agent to handle. This may include applying a variety of rules metadata detailing various conditions that may determine when community content 300 should be elevated. Accordingly, community content 300 may be compared with the rules metadata to determine whether it should be elevated.

For example, the number of posts from customers providing answers may be used to determine whether community content 300 should be elevated to a customer service case record. In some implementations, if a number of other customers providing posts including possible answers to post 305 (i.e., respond to post 305) exceed a threshold number, then community content 300 may be related to a popular subject matter that should receive attention from a customer service agent. For example, in FIG. 3, community content 300 may be elevated to a customer service case record if two or more posts responding to post 305 are generated. Since posts 310 and 315 are generated by other customers, community content 300 may be elevated to a customer service case record. In another implementation, the rate of posts of other customers providing possible answers to post 305 also may be used to indicate a popular subject matter that should receive attention from a customer service agent. For example, if the rate of posts exceeds a threshold rate (e.g., five posts per minute), then the rules metadata may indicate that community content 300 can be elevated.

In some implementations, natural language processing (NLP) may be used to detect particular a subject matter of community content 300. Community content with certain subject matter may be elevated to customer service case records. For example, a product may be under a recall due to safety, and therefore, if community content 300 refers to the product it may be elevated to a customer service case record so that a customer service agent may be able to quickly resolve the problem.

In some implementations, NLP may also be used to determine a sentiment of community content 300. For example, positive, negative, and neutral sentiment or feelings may be determined and used to elevate community content 300 to a customer service case record. If post 305 (i.e., the initial post from the customer asking the question) is negative, then community content 300 may be elevated to a customer service case record. In some implementations, if post 305 is positive but posts 310 and 315 are negative (i.e., the posts from other customers responding to post 305), then community content 300 may be elevated to a customer service case record. In some implementations, if a percentage of posts responding to post 305 are negative (e.g., a percentage of total posts responding to post 305 pass a threshold percentage), then community content 300 may be elevated to a customer service case record so that a customer service agent may be alerted to solve the problem and potentially stop growing negative feedback. In some implementations, if a threshold number of negative posts responding to post 305 is reached, then community content 300 may be elevated to a customer service case record.

In some implementations, if another customer has not provided a post in response to post 305, then community content 300 may be elevated to a customer service case record. For example, if post 305 does not generate responses from other customers (i.e., posts 310 and 315 are not generated) within a time frame indicated by the rules metadata (e.g., 24 hours), then a customer service case record should be generated so that a customer service agent may be able to provide assistance to the customer asking a question as indicated in post 305.

In some implementations, customer relationship management (CRM) records associated with the customer asking the question (e.g., the customer providing post 305) may be accessed to retrieve CRM data that may be analyzed with the rules metadata to determine whether community content 300 should be escalated. CRM records often include data regarding an organization's interactions with current, past, and future (e.g., potential) customers that may be useful for sales, marketing, and customer service.

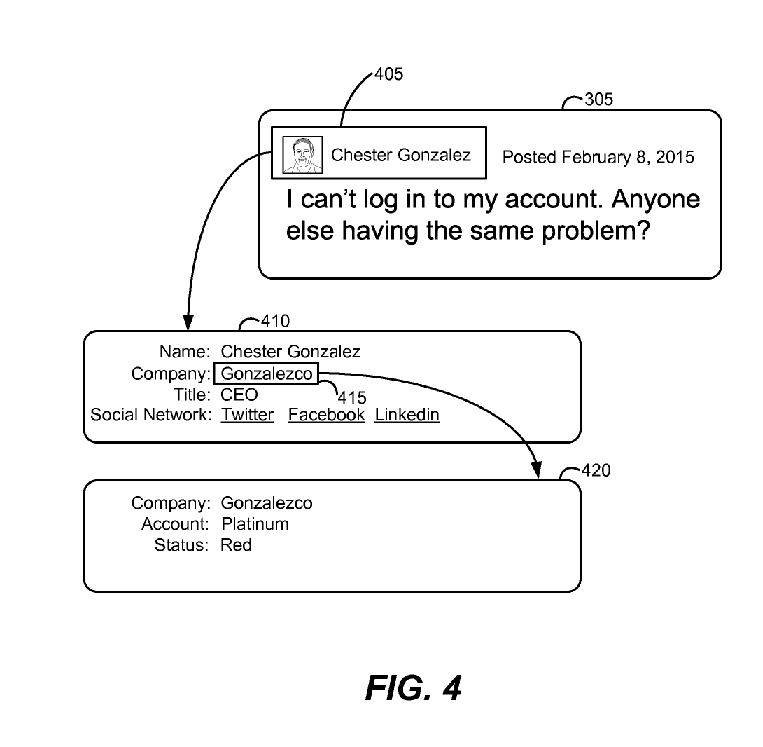

FIG. 4 shows an example of community content data associated with customer relationship management (CRM) records according to some implementations. In FIG. 4, post 305 may include customer name 405 indicating that “Chester Gonzalez” provided the content of post 305. Chester Gonzalez may be a current customer of the organization, and therefore, an existing CRM record for Chester Gonzalez may be accessed to provide data that can be used to determine whether to escalate community content 300 to a customer service case record.

For example, in FIG. 4, CRM record 410 corresponding to customer name 405 may indicate that the customer works for “Gonzalezco” in company name 415 and that data may be used to elevate community content 300. That is, community content 300 may be elevated based on an employer of the customer being in a list of employers whose employees should have their questions elevated in the rules metadata.

Moreover, CRM record 415 includes additional information regarding the customer, for example, a position within company name 415. In some implementations, if post 305 is provided by a customer of a certain position, then a customer service case record may be generated. For example, customers in a positional hierarchy of an organization at the level of vice president and higher (e.g., a range from vice president to CEO or chairperson) may result in community content 300 being elevated, but if post 305 is provided by a customer beneath the vice president level within the positional hierarchy (i.e., at a lower level of the hierarchy) then community content 300 may not be elevated. In some implementations, the range of levels within the hierarchy may include management level employees (e.g., managers, senior managers) but exclude higher (e.g., directors, senior directors, etc.) and lower level employees (e.g., individual contributors reporting to managers). In some implementations, if post 305 is at a lower level of the hierarchy, but posts 310 or 315 are from a customer at a higher level (e.g., vice president or higher), then community content 300 may be elevated as the question has received attention of a customer at a high-level position within a company. Accordingly, CRM records of the customers responding to post 305 may also be accessed to determine whether to elevate community content 300.

CRM records may also include information regarding company name 415 (i.e., the employer of the customer). CRM record 420 in FIG. 4 includes additional information regarding the employer, for example, an account type and status. In FIG. 4, an account type may be a level within a service level hierarchy with each level in the hierarchy detailing a different level of commitment that the organization is to provide in resolving problems. That is, customers or companies in the different levels may be provided different services. For example, a customer with a “platinum” account type may be offered a solution to a problem within 24 hours by a customer service agent, and therefore, if post 305 is from a customer at an employer indicated as having a platinum account, then the corresponding community content 300 should be elevated so that a customer service agent may be able to fulfill the commitment to be provided to platinum accounts. A “gold” account may include different services (i.e., it is at a lower level in the service level hierarchy). For example, a solution to a problem may be offered within 72 hours, and therefore, it may be elevated later than a platinum account. A “bronze” account may not have associated questions elevated to a customer service case record.

Additionally, the status of the customer's employer with respect to the organization providing support with customer service agents may also be considered. For example, a relationship between the customer's employer to the organization may be in trouble, therefore, community content 300 should be elevated. In FIG. 4, the status in CRM record 420 is indicated as “red.” Red may indicate that the relationship is in jeopardy, and therefore, the question may be elevated. By contrast, a “green” status may indicate that the relationship is in good shape, and therefore, the case does not need to be elevated.

In some implementations, social network data (or social media data) from a customer's social network profile characteristics or activities may also be used to determine whether to elevate community content 300. For example, in FIG. 4, CRM record 410 indicates that the customer of post 305 has three social networking accounts. In some implementations, the followers, friends, and other contacts of the customer may be used to determine whether to elevate community content 300. For example, if the customer providing post 305 has 100 or more followers on Twitter, then the customer may be influential on a social network, and therefore, the customer's question should be elevated to a customer service case record so that a customer service agent may be able to quickly resolve the problem without the customer negatively commenting on the organization's product on a social network.

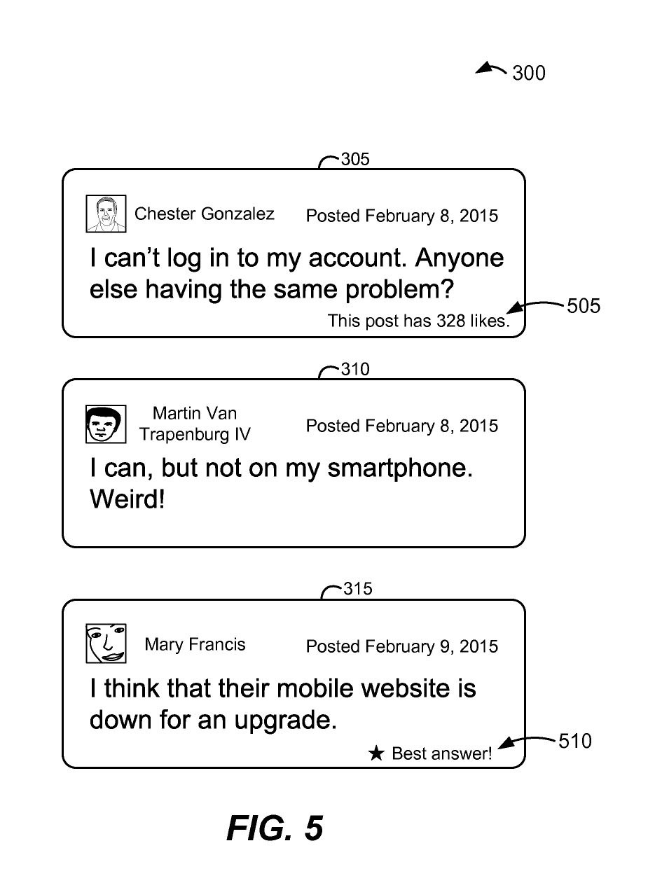

In some implementations, the attention post 305 receives can also be used to elevate community content 300. For example, as customers view community content 300 and a threshold number of customer views is reached, community content 300 may be elevated. Additionally, community content 300 can be elevated if post 305 receives a certain number of “likes” indicating that other customers like or are interested in the answer to the question in post 305. For example, FIG. 5 shows another example of community content data according to some implementations. In FIG. 5, likes 505 indicates that post 305 is of interest to 328 customers. If the rules metadata specify that 300 or more likes indicates that community content should be elevated to a customer service case record, then community content 300 including post 305 may be elevated because likes 505 indicates over 300 likes.

Accordingly, at block 220, a customer service case record can be generated. For example, community content 300 in FIG. 3 can be used to generate the customer service case record including the content (e.g., text, images, videos, etc.) of posts 305, 310, 315, CRM data associated with the customer of post 305, social network data associated with the customer of post 305, the date and time of post 305, the name of the customer of post 305 (as well as the other posts such as posts 310 and 315), and any other data useful for resolving the question asked by the customer.

At block 225, a customer service agent, for example using agent system 125, can request the customer service case record. For example, the customer service agent may go through a log of customer service case records to review the issues that customers are having and begin to provide answers. At block 230, the record can be provided and the customer service agent can receive the case at block 235.

At block 240, the customer service agent can respond to the problem indicated in the customer service case record. When the customer service case record is generated, the content of post 305 of community content 300 may be stored in the customer service case record, along with the content of posts 310 and 315. That is, the customer service agent may be able to have access to and observe post 305 (i.e., the initial post asking a question) and posts 310 and 315 (i.e., subsequent posts from other customers responding to the question) without logging into the community website. For example, the customer service agent may be provided a visual representation of the data of the customer service case record including posts 305, 310, and 315. As such, the customer service agent may be able to fill in a field or comment box with text and attach media (e.g., images, videos, audio, etc.) to answer the question in post 305.

At block 250, the customer service agent's response can be used to modify the community content data. For example, the customer service agent's response can be added as a new post to community content 300. In some implementations, the customer service agent's post may be emphasized so that customers can recognize a response from the customer service agent. For example, the response can be inserted underneath post 305 and above other posts (e.g., above posts 310 and 315), or placed in another geometric position so that it is easily visible to customers viewing community content 300.

In some implementations, the customer service agent may recognize that a post provided by another customer responding to post 305 provides a good answer. For example, in FIG. 5 post 315 is indicated as a “best answer” with indicator 510. Indicator 510 may be a textual, graphical, or other type of identifier of a post responding to post 305 that the customer service agent has selected as being a good answer using the customer service case record, and therefore, indicator 510 may be attached to post 315 in community content 300 to draw attention from other customers viewing community content 300 with the same question as the customer of post 305. Accordingly, the customer service agent can select post 315 from the customer service case record, indicate it as a good answer, and have post 315 in community content 300 updated to reflect the customer service agent's decision.

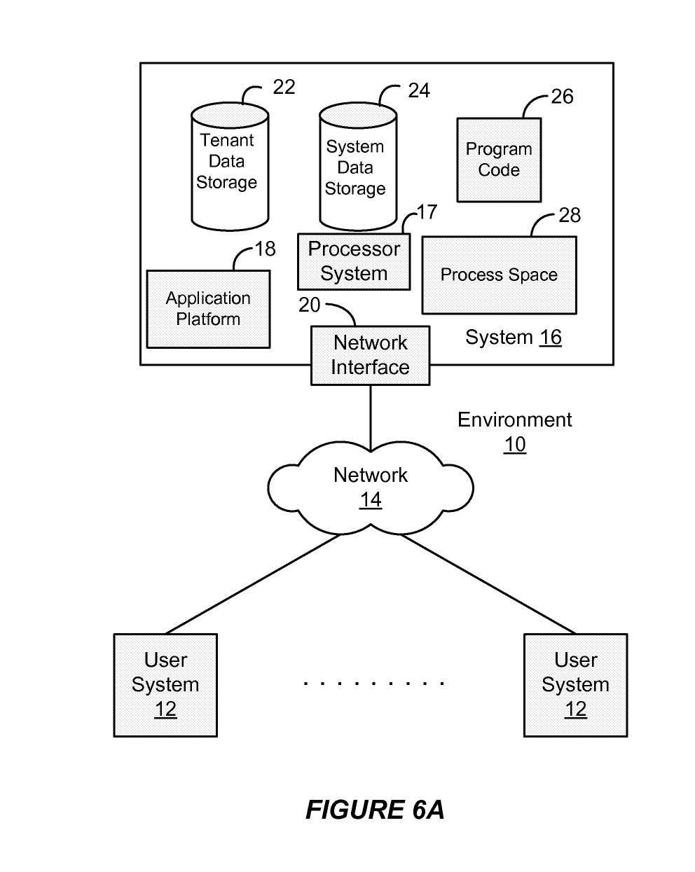

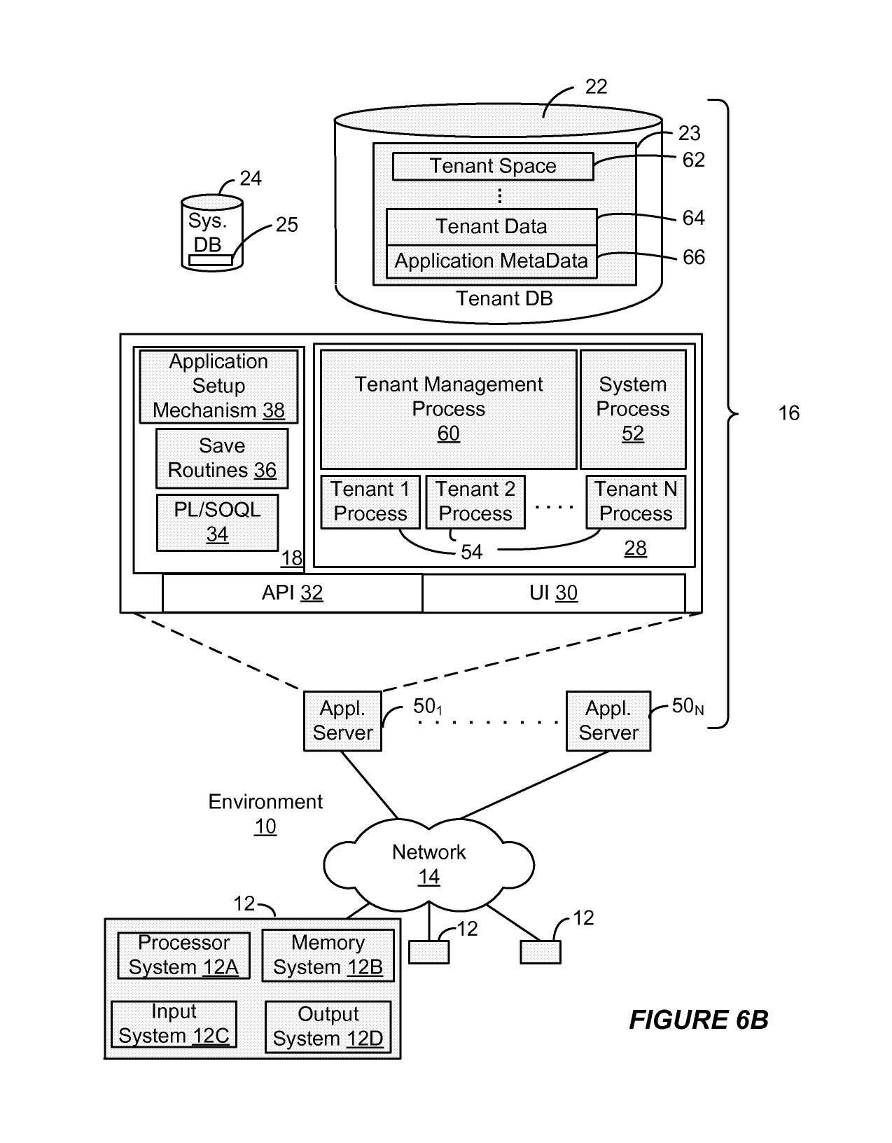

FIG. 6A shows a block diagram of an example of an environment 10 in which an on-demand database service can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

Environment 10 is an environment in which an on-demand database service exists. User system 12 may be implemented as any computing device(s) or other data processing apparatus such as a machine or system that is used by a user to access a database system 16. For example, any of user systems 12 can be a handheld computing device, a mobile phone, a laptop computer, a work station, and/or a network of such computing devices. As illustrated in FIG. 6A (and in more detail in FIG. 6B) user systems 12 might interact via a network 14 with an on-demand database service, which is implemented in the example of FIG. 6A as database system 16.

An on-demand database service, implemented using system 16 by way of example, is a service that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 6A, implements a web-based customer relationship management (CRM) system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 6A and 6B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 6A include conventional, well-known elements that are explained only briefly here. For example, each user system 12 could include a desktop personal computer, workstation, laptop, PDA, tablet, smartphone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 6B shows a block diagram of an example of some implementations of elements of FIG. 6A and various possible interconnections between these elements. That is, FIG. 6B also illustrates environment 10. However, in FIG. 6B elements of system 16 and various interconnections in some implementations are further illustrated. FIG. 6B shows that user system 12 may include processor system 12A, memory system 12B, input system 12C, and output system 12D. FIG. 6B shows network 14 and system 16. FIG. 6B also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 6A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 6B, system 16 may include a network interface 20 (of FIG. 6A) implemented as a set of HTTP application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

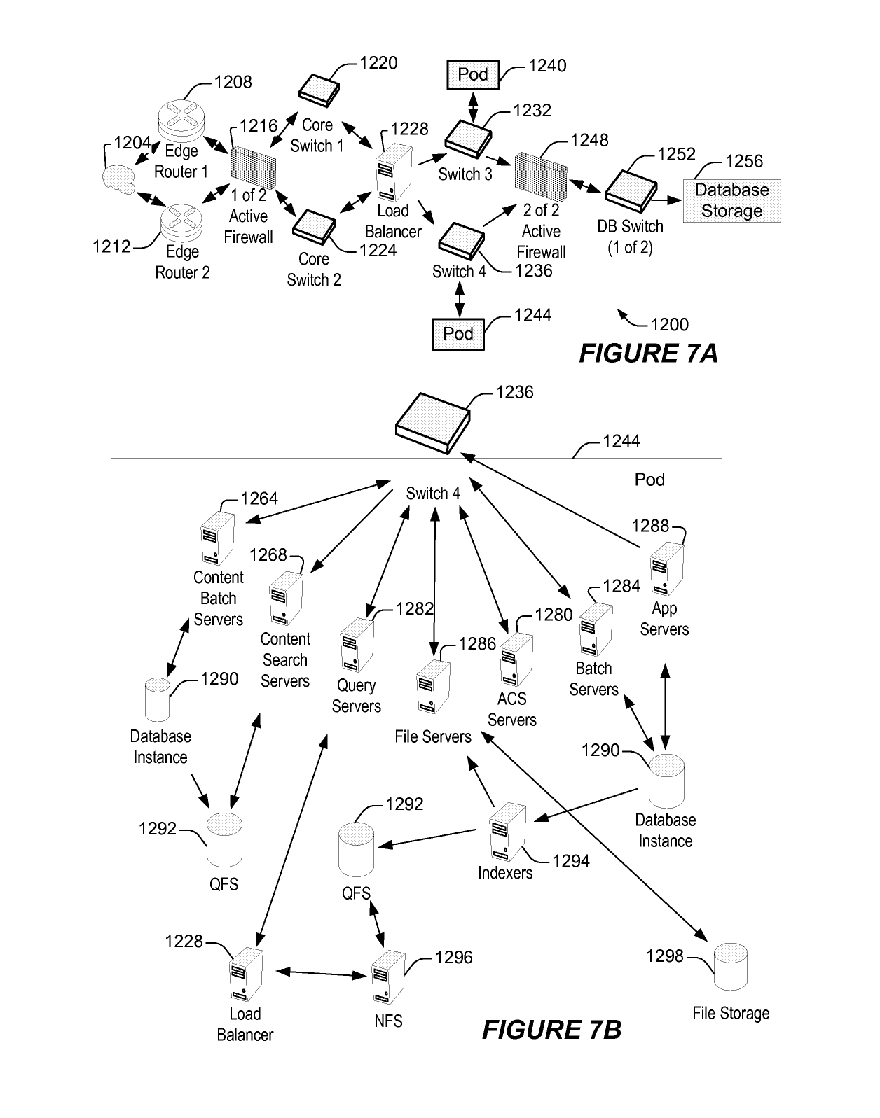

FIG. 7A shows a system diagram illustrating an example of architectural components of an on-demand database service environment 1200 according to some implementations. A client machine located in the cloud 1204, generally referring to one or more networks in combination, as described herein, may communicate with the on-demand database service environment via one or more edge routers 1208 and 1212. A client machine can be any of the examples of user systems 12 described above. The edge routers may communicate with one or more core switches 1220 and 1224 via firewall 1216. The core switches may communicate with a load balancer 1228, which may distribute server load over different pods, such as the pods 1240 and 1244. The pods 1240 and 1244, which may each include one or more servers and/or other computing resources, may perform data processing and other operations used to provide on-demand services. Communication with the pods may be conducted via pod switches 1232 and 1236. Components of the on-demand database service environment may communicate with a database storage 1256 via a database firewall 1248 and a database switch 1252.

As shown in FIGS. 7A and 7B, accessing an on-demand database service environment may involve communications transmitted among a variety of different hardware and/or software components. Further, the on-demand database service environment 1200 is a simplified representation of an actual on-demand database service environment. For example, while only one or two devices of each type are shown in FIGS. 7A and 7B, some implementations of an on-demand database service environment may include anywhere from one to many devices of each type. Also, the on-demand database service environment need not include each device shown in FIGS. 7A and 7B, or may include additional devices not shown in FIGS. 7A and 7B.

Moreover, one or more of the devices in the on-demand database service environment 1200 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 1204 is intended to refer to a data network or plurality of data networks, often including the Internet. Client machines located in the cloud 1204 may communicate with the on-demand database service environment to access services provided by the on-demand database service environment. For example, client machines may access the on-demand database service environment to retrieve, store, edit, and/or process information.

In some implementations, the edge routers 1208 and 1212 route packets between the cloud 1204 and other components of the on-demand database service environment 1200. The edge routers 1208 and 1212 may employ the Border Gateway Protocol (BGP). The BGP is the core routing protocol of the Internet. The edge routers 1208 and 1212 may maintain a table of IP networks or ‘prefixes’, which designate network reachability among autonomous systems on the Internet.

In one or more implementations, the firewall 1216 may protect the inner components of the on-demand database service environment 1200 from Internet traffic. The firewall 1216 may block, permit, or deny access to the inner components of the on-demand database service environment 1200 based upon a set of rules and other criteria. The firewall 1216 may act as one or more of a packet filter, an application gateway, a stateful filter, a proxy server, or any other type of firewall.

In some implementations, the core switches 1220 and 1224 are high-capacity switches that transfer packets within the on-demand database service environment 1200. The core switches 1220 and 1224 may be configured as network bridges that quickly route data between different components within the on-demand database service environment. In some implementations, the use of two or more core switches 1220 and 1224 may provide redundancy and/or reduced latency.

In some implementations, the pods 1240 and 1244 may perform the core data processing and service functions provided by the on-demand database service environment. Each pod may include various types of hardware and/or software computing resources. An example of the pod architecture is discussed in greater detail with reference to FIG. 7B.

In some implementations, communication between the pods 1240 and 1244 may be conducted via the pod switches 1232 and 1236. The pod switches 1232 and 1236 may facilitate communication between the pods 1240 and 1244 and client machines located in the cloud 1204, for example via core switches 1220 and 1224. Also, the pod switches 1232 and 1236 may facilitate communication between the pods 1240 and 1244 and the database storage 1256.

In some implementations, the load balancer 1228 may distribute workload between the pods 1240 and 1244. Balancing the on-demand service requests between the pods may assist in improving the use of resources, increasing throughput, reducing response times, and/or reducing overhead. The load balancer 1228 may include multilayer switches to analyze and forward traffic.

In some implementations, access to the database storage 1256 may be guarded by a database firewall 1248. The database firewall 1248 may act as a computer application firewall operating at the database application layer of a protocol stack. The database firewall 1248 may protect the database storage 1256 from application attacks such as structure query language (SQL) injection, database rootkits, and unauthorized information disclosure.

In some implementations, the database firewall 1248 may include a host using one or more forms of reverse proxy services to proxy traffic before passing it to a gateway router. The database firewall 1248 may inspect the contents of database traffic and block certain content or database requests. The database firewall 1248 may work on the SQL application level atop the TCP/IP stack, managing applications' connection to the database or SQL management interfaces as well as intercepting and enforcing packets traveling to or from a database network or application interface.

In some implementations, communication with the database storage 1256 may be conducted via the database switch 1252. The multi-tenant database storage 1256 may include more than one hardware and/or software components for handling database queries. Accordingly, the database switch 1252 may direct database queries transmitted by other components of the on-demand database service environment (e.g., the pods 1240 and 1244) to the correct components within the database storage 1256.

In some implementations, the database storage 1256 is an on-demand database system shared by many different organizations. The on-demand database system may employ a multi-tenant approach, a virtualized approach, or any other type of database approach. An on-demand database system is discussed in greater detail with reference to FIGS. 7A and 7B.

FIG. 7B shows a system diagram further illustrating an example of architectural components of an on-demand database service environment according to some implementations. The pod 1244 may be used to render services to a user of the on-demand database service environment 1200. In some implementations, each pod may include a variety of servers and/or other systems. The pod 1244 includes one or more content batch servers 1264, content search servers 1268, query servers 1282, file servers 1286, access control system (ACS) servers 1280, batch servers 1284, and app servers 1288. Also, the pod 1244 includes database instances 1290, quick file systems (QFS) 1292, and indexers 1294. In one or more implementations, some or all communication between the servers in the pod 1244 may be transmitted via the switch 1236.

In some implementations, the app servers 1288 may include a hardware and/or software framework dedicated to the execution of procedures (e.g., programs, routines, scripts) for supporting the construction of applications provided by the on-demand database service environment 1200 via the pod 1244. In some implementations, the hardware and/or software framework of an app server 1288 is configured to execute operations of the services described herein, including performance of the blocks of methods described with reference to FIGS. 1-4. In alternative implementations, two or more app servers 1288 may be included and cooperate to perform such methods, or one or more other servers described herein can be configured to perform the disclosed methods.

The content batch servers 1264 may handle requests internal to the pod. These requests may be long-running and/or not tied to a particular customer. For example, the content batch servers 1264 may handle requests related to log mining, cleanup work, and maintenance tasks.

The content search servers 1268 may provide query and indexer functions. For example, the functions provided by the content search servers 1268 may allow users to search through content stored in the on-demand database service environment.

The file servers 1286 may manage requests for information stored in the File storage 1298. The File storage 1298 may store information such as documents, images, and basic large objects (BLOBs). By managing requests for information using the file servers 1286, the image footprint on the database may be reduced.

The query servers 1282 may be used to retrieve information from one or more file systems. For example, the query system 1282 may receive requests for information from the app servers 1288 and then transmit information queries to the NFS 1296 located outside the pod.

The pod 1244 may share a database instance 1290 configured as a multi-tenant environment in which different organizations share access to the same database. Additionally, services rendered by the pod 1244 may call upon various hardware and/or software resources. In some implementations, the ACS servers 1280 may control access to data, hardware resources, or software resources.

In some implementations, the batch servers 1284 may process batch jobs, which are used to run tasks at specified times. Thus, the batch servers 1284 may transmit instructions to other servers, such as the app servers 1288, to trigger the batch jobs.

In some implementations, the QFS 1292 may be an open source file system available from Sun Microsystems® of Santa Clara, Calif. The QFS may serve as a rapid-access file system for storing and accessing information available within the pod 1244. The QFS 1292 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 1268 and/or indexers 1294 to identify, retrieve, move, and/or update data stored in the network file systems 1296 and/or other storage systems.

In some implementations, one or more query servers 1282 may communicate with the NFS 1296 to retrieve and/or update information stored outside of the pod 1244. The NFS 1296 may allow servers located in the pod 1244 to access information to access files over a network in a manner similar to how local storage is accessed.

In some implementations, queries from the query servers 1222 may be transmitted to the NFS 1296 via the load balancer 1228, which may distribute resource requests over various resources available in the on-demand database service environment. The NFS 1296 may also communicate with the QFS 1292 to update the information stored on the NFS 1296 and/or to provide information to the QFS 1292 for use by servers located within the pod 1244.

In some implementations, the pod may include one or more database instances 1290. The database instance 1290 may transmit information to the QFS 1292. When information is transmitted to the QFS, it may be available for use by servers within the pod 1244 without using an additional database call.

In some implementations, database information may be transmitted to the indexer 1294. Indexer 1294 may provide an index of information available in the database 1290 and/or QFS 1292. The index information may be provided to file servers 1286 and/or the QFS 1292.

As multiple users might be able to change the data of a record, it can be useful for certain users to be notified when a record is updated. Also, even if a user does not have authority to change a record, the user still might want to know when there is an update to the record. For example, a vendor may negotiate a new price with a salesperson of company X, where the salesperson is a user associated with tenant Y. As part of creating a new invoice or for accounting purposes, the salesperson can change the price saved in the database. It may be important for co-workers to know that the price has changed. The salesperson could send an email to certain people, but this is onerous and the salesperson might not email all of the people who need to know or want to know. Accordingly, some implementations of the disclosed techniques can inform others (e.g., co-workers) who want to know about an update to a record automatically.

The tracking and reporting of updates to a record stored in a database system can be facilitated with a multi-tenant database system 16, e.g., by one or more processors configured to receive or retrieve information, process the information, store results, and transmit the results. In other implementations, the tracking and reporting of updates to a record may be implemented at least partially with a single tenant database system.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

While the disclosed examples are often described herein with reference to an implementation in which an on-demand database service environment is implemented in a system having an application server providing a front end for an on-demand database service capable of supporting multiple tenants, the present implementations are not limited to multi-tenant databases nor deployment on application servers. Implementations may be practiced using other database architectures, i.e., ORACLE®, DB2® by IBM and the like without departing from the scope of the implementations claimed.

It should be understood that some of the disclosed implementations can be embodied in the form of control logic using hardware and/or using computer software in a modular or integrated manner. Other ways and/or methods are possible using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A database system configured to generate a case in a customer support analyst database, the database system comprising:
at least one server having at least one processor capable of executing instructions configured to cause:
determining a community content item includes content posted by a user;
comparing characteristics of the community content item with rules metadata indicating the characteristics to generate a case in the customer support analyst database, the comparing including accessing a customer relationship management (CRM) record corresponding to the user to determine one or more of the characteristics of the community content item; and
generating a case record in the customer support analyst database, the case record corresponding to the community content item and including the content posted by the customer, the case record generated responsive to the comparison of the characteristics with the rules metadata.

2. The database system of claim 1, wherein the community content item also includes content posted by other users.

3. The database system of claim 2, wherein the comparing also includes determining that a number of the other users exceeds a threshold number, and the rules metadata indicating that the community content item is to be used to generate a case based on the number of the other users exceeding the threshold number.

4. The database system of claim 1, wherein the comparing also includes determining that the CRM record indicates that the user holds an organizational role at an employer, and wherein the rules metadata indicates that the community content item is to be used to generate a case based on the organizational role being within a range of levels of an organizational hierarchy of the employer.

5. The database system of claim 4, wherein the rules metadata indicate that a status of a relationship of the employer is also used to generate the case.

6. The database system of claim 1, wherein the comparing also includes determining that the user is associated with a profile on a social network including a number of followers, the followers being other members of the social network, and wherein the rules metadata indicates that the community content item is to be used to generate a case based on the number of followers being above a threshold number.

7. The database system of claim 1, the least one server having at least one processor capable of executing instructions further configured to cause:
modifying the community content item to include a response by a customer service agent to the content posted by the user.

8. A computer implemented method for generating a case in a customer support analyst database of a database system, the method comprising:
determining, by the database system, a community content item includes content posted by a user;
comparing, by the database system, characteristics of the community content item with rules metadata indicating the characteristics to generate a case in the customer support analyst database, the comparing including accessing a customer relationship management (CRM) record corresponding to the user to determine one or more of the characteristics of the community content item; and
generating, by the database system, a case record in the customer support analyst database, the case record corresponding to the community content item and including the content posted by the user, the case record generated responsive to the comparison of the characteristics with the rules metadata.

9. The computer implemented method of claim 1, wherein the community content item also includes content posted by other users.

10. The computer implemented method of claim 9, wherein the comparing also includes determining that a number of the other users exceeds a threshold number, and the rules metadata indicating that the community content item is to be used to generate a case based on the number of the other users exceeding the threshold number.

11. The computer implemented method of claim 8, wherein the comparing also includes determining that the CRM record indicates that the user holds an organizational role at an employer, and wherein the rules metadata indicates that the community content item is to be used to generate a case based on the organizational role being within a range of levels of an organizational hierarchy of the employer.

12. The computer implemented method of claim 11, wherein the rules metadata indicate that a status of a relationship of the employer is also used to generate the case.

13. The computer implemented method of claim 8, wherein the comparing also includes determining that the user is associated with a profile on a social network including a number of followers, the followers being other members of the social network, and wherein the rules metadata indicates that the community content item is to be used to generate a case based on the number of followers being above a threshold number.

14. The computer implemented method of claim 8, the least one server having at least one processor capable of executing instructions further configured to cause:
modifying the community content item to include a response by a customer service agent to the content posted by the user.

15. A computer program product comprising program code to be executed by at least one processor when retrieved from a non-transitory computer-readable medium, the program code comprising instructions configured to cause:
determining a community content item includes content posted by a user;
comparing characteristics of the community content item with rules metadata indicating the characteristics to generate a case in the customer support analyst database, the comparing including accessing a customer relationship management (CRM) record corresponding to the user to determine one or more of the characteristics of the community content item; and
generating a case record in the customer support analyst database, the case record corresponding to the community content item and including the content posted by the user, the case record generated responsive to the comparison of the characteristics with the rules metadata.

16. The computer program product of claim 15, wherein the community content item is updated to include content posted by other users.

17. The computer program product of claim 16, wherein the comparing also includes determining that a number of the other users exceeds a threshold number, and the rules metadata indicating that the community content item is to be used to generate a case based on the number of the other users exceeding the threshold number.

18. The computer program product of claim 15, wherein the comparing also includes determining that the CRM record indicates that the user holds an organizational role at an employer, and wherein the rules metadata indicates that the community content item is to be used to generate a case based on the organizational role being within a range of levels of an organizational hierarchy of the employer.

19. The computer program product of claim 18, wherein the rules metadata indicate that a status of a relationship of the employer is also used to generate the case.

20. The computer program product of claim 15, wherein the comparing also includes determining that the user is associated with a profile on a social network including a number of followers, the followers being other members of the social network, and wherein the rules metadata indicates that the community content item is to be used to generate a case based on the number of followers being above a threshold number.

21. The computer program product of claim 15, wherein the rules metadata indicates that a determination that the community content item is not answered within a threshold time period is to be used to generate the case.
